(19) United States
(12) Patent Application Publication
(10) Pub. No.: US 2021/0319481 A1
(43) Pub. Date: Oct. 14, 2021

(54) SYSTEM AND METHOD FOR SUMMERIZATION OF CUSTOMER INTERACTION

(71) Applicant: PM Labs, Inc., Walnut, CA (US)

(72) Inventors: Arjun Maheswaran, Bangalore (IN); K B. Rahul, Bangalore (IN); Piyank Sarawagi, Patna (IN)

(73) Assignee: PM Labs, Inc.

(21) Appl. No.: 16/846,507

(22) Filed: Apr. 13, 2020

(51) Int. Cl. G06Q 30/02; G06F 40/30; G06F 40/284; G10L 15/26

(52) U.S. Cl. CPC G06Q 30/0281; G10L 15/265; G06F 40/284; G06F 40/30

(57) ABSTRACT

A system for summarization of customer interaction is disclosed. The system includes a customer interaction subsystem to receive an input corpus. The system includes a token scorer including an issue prediction module to receive multiple tokens by splitting the input corpus. The issue prediction module includes the attention module to apply attention models hierarchically on the multiple tokens to obtain a machine-readable issue profile. The issue prediction module computes an issue prediction probability for each token based on the issue machine profile. The system includes a phrase extractor subsystem to extract phrases from the input corpus based on a set of predefined sentencing rules. The system includes a phrase selector subsystem to map each phrase with the corresponding issue prediction probability. The phrase selector subsystem selects at least one phrase including a token having the issue prediction probability above a predefined threshold probability from the phrases for summarization of customer interaction.

### BACKGROUND

Embodiment of the present disclosure relates to natural language processing, and more particularly to, a system and a method for summarization of customer interaction.

The volume of information available for consumption continues to grow at an unprecedented pace, which leads to a corresponding increase in information overload. One approach to such issue involves automatic data summarization, which typically provides a summary of the key elements of an input corpus of content. The automatic data summarization includes a computer's attempts to understand and interpret content in human language, whether written or oral. Natural language processing (NLP) involves linguistics, computer science, and artificial intelligence. Recent natural language processing involves automatically learning of interpretational rules through the analysis of large corpus. However, conventional natural language processing techniques are unable to identify how several sentences or expressions of multiple sentiments are connected together for the purpose of creating a coherent summary of a collection of several sentences over time.

Furthermore, certain existing approaches utilize graph-based algorithms to calculate the importance of sentences within a body of text as well as static features of individual sentences. However, such approaches are unable to distinguish between various terms that are scored through the assignment of sentence which may further affect the accuracy of the resulting summary.

Hence, there is a need for an improved system and method for summarization of customer interaction to address the aforementioned issue(s).

### BRIEF DESCRIPTION

In accordance with an embodiment of the present disclosure, a system for summarization of customer interaction is provided. The system includes a customer interaction subsystem configured to receive an input corpus from one or more customers. The system also includes a token scorer subsystem operatively coupled to the customer interaction subsystem. The token scorer subsystem includes an issue prediction module configured to receive a plurality of tokens by splitting the input corpus. The issue prediction module also includes an attention module configured to apply one or more attention models hierarchically on the plurality of tokens to obtain a machine-readable issue profile. The issue prediction module is also configured to compute an issue prediction probability for each of the plurality of tokens based on the issue machine profile obtained by the attention module. The system further includes a phrase extractor subsystem operatively coupled to the customer interaction subsystem. The phrase extractor subsystem is configured to extract one or more phrases from the input corpus based on a set of predefined sentencing rules. The system further includes a phrase selector subsystem operatively coupled to the token scorer subsystem and the phrase extractor subsystem. The phrase selector subsystem is configured to map each of the one or more phrases extracted by the phrase extractor subsystem with the corresponding issue prediction probability computed by the issue prediction module. The phrase selector subsystem is also configured to select at least one phrase including a token having the issue prediction probability above a predefined threshold probability from the one or more phrases for summarization of customer interaction.

In accordance with an embodiment of the present disclosure, a method for summarization of customer interaction is provided. The receiving, by a customer interaction subsystem, an input corpus from one or more customers. The method also includes receiving, by an issue prediction module, a plurality of tokens by splitting the input corpus. The method further includes applying, by an attention module, one or more attention models hierarchically on the plurality of tokens to obtain a machine-readable issue profile. The method further includes computing, by the issue prediction module, an issue prediction probability for each of the plurality of tokens based on the issue machine profile obtained by the attention module. The method further includes extracting, by a phrase extractor subsystem, one or more phrases from the input corpus based on a set of predefined sentencing rules. The method further includes mapping, by a phrase selector subsystem, each of the one or more phrases extracted by the phrase extractor subsystem with the corresponding issue prediction probability computed by the issue prediction module. The method further includes selecting, by the phrase selector subsystem, at least one phrase comprising a token having the issue prediction probability above a predefined threshold probability from the one or more phrases for summarization of customer interaction.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for summarization of customer interaction in accordance with an embodiment of the present disclosure;

FIG. 2 is a block diagram representation of one embodiment of the system for summarization of customer interaction of FIG. 1 in accordance with an embodiment of the present disclosure;

FIG. 3 is a schematic representation of an exemplary system for summarization of customer interaction of FIG. 1 in accordance with an embodiment of the present disclosure;

FIG. 4 is a schematic representation of a context graph of FIG. 3 in accordance with an embodiment of the present disclosure;

FIG. 5 is a block diagram of a computer or a server in accordance with an embodiment of the present disclosure; and

FIG. 6 is a flow chart representing the steps involved in a method for summarization of customer interaction in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or subsystems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system for summarization of customer interaction. The system includes a customer interaction subsystem to receive an input corpus from customers. The system also includes a token scorer subsystem operatively coupled to the customer interaction subsystem. The token scorer subsystem includes an issue prediction module to receive multiple tokens by splitting the input corpus. The issue prediction module includes an attention module to apply attention models hierarchically on the multiple tokens to obtain a machine-readable issue profile. The issue prediction module computes an issue prediction probability for each token based on the issue machine profile obtained by the attention module. The system further includes a phrase extractor subsystem operatively coupled to the customer interaction subsystem. The phrase extractor subsystem extracts one or more phrases from the input corpus based on a set of predefined sentencing rules. The system further includes a phrase selector subsystem operatively coupled to the token scorer subsystem and the phrase extractor subsystem. The phrase selector subsystem maps each phrase extracted by the phrase extractor subsystem with the corresponding issue prediction probability computed by the issue prediction module. The phrase selector subsystem selects at least one phrase including a token having the issue prediction probability above a predefined threshold probability from the one or more phrases for summarization of customer interaction.

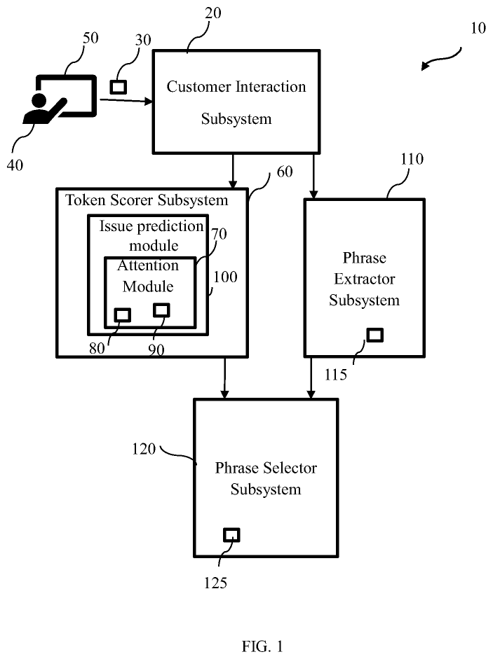

FIG. 1 is a block diagram representation of a system 10 for summarization of customer interaction in accordance with an embodiment of the present disclosure. The system 10 includes a customer interaction subsystem 20 to receive an input corpus 30 from customers 40. In one embodiment, the customer interaction subsystem 20 may receive the input corpus 30 from the interaction of the customers 40 with the customer interaction subsystem 20. In such an embodiment, the customer interaction subsystem 20 may receive text or voice of the customer interaction. In one embodiment, the text or voice of the customer interaction may include at least one of web content, text of a chat session, an email, a short messaging service, a voice call or a voice message. In a specific embodiment, the customer interaction subsystem 20 may convert the voice received from customer interaction into text (input corpus 30) using natural language processing models. As used herein, the term “corpus” is defined as a collection of written texts. In such an embodiment, the input corpus may be parsed using a natural language parser.

In one embodiment, the customers 40 may interact with the customer interaction subsystem 20 via a corresponding customer interface 50. In such an embodiment, the customer interface 50 may be an interface of a mobile phone or a computer system. The customer interface 50 and the customer interaction subsystem 20 communicate via a network (not shown in FIG. 1). In one embodiment, the network may be a wired network such as local area network (LAN). In another embodiment, the network may be a wireless network such as wi-fi, radio communication medium or the like. In a specific embodiment, the system 10 may be located on a local server. In another embodiment, the system 10 may be located on a cloud server.

The system 10 also includes a token scorer subsystem 60 operatively coupled to the customer interaction subsystem 20. The token scorer subsystem 60 includes an issue prediction module 100 to split the input corpus 30 into multiple tokens 80. To create multiple tokens 80, the issue prediction module 100 identifies boundaries of the words within the input corpus. Upon identification of the boundaries, the issue prediction module 100 splits the customer query into sentences and sentences into the multiple tokens 80. In one embodiment, the multiple tokens 80 may include words, numbers, punctuation marks, date, email address or universal resource locator (URL). Further, the issue prediction module 100 includes an attention module 70 which applies various attention models hierarchically on the multiple tokens 80 to obtain a machine-readable issue profile 90. More specifically, the attention module 70 assigns machine-readable codes to corresponding tokens 80. The machine-readable codes are representative of text in an n-dimensional space and is a learned representation for text where words which have the same meaning have a similar representation. The n-dimensional space may include a numeric representation of each token. The various attention models are applied to obtain representation of the sentences such that the representation carries information of context.

Upon identification of the context using various attention models, the attention module 70 may identify several details from the input corpus 30 such as a product detail, an issue detail and a customer detail or the like. Once the product, the issue, the customer details are identified from the multiple tokens 80, the attention module 70 determines a product profile, an issue profile and a customer profile. Each profile attains machine-readable code from the previous profile in the hierarchy and applies the corresponding attention model to generate machine-readable codes for the next profile in the hierarchy. Hence, the attention module 70 obtains the machine-readable issue profile 90 from the aforementioned profiles.

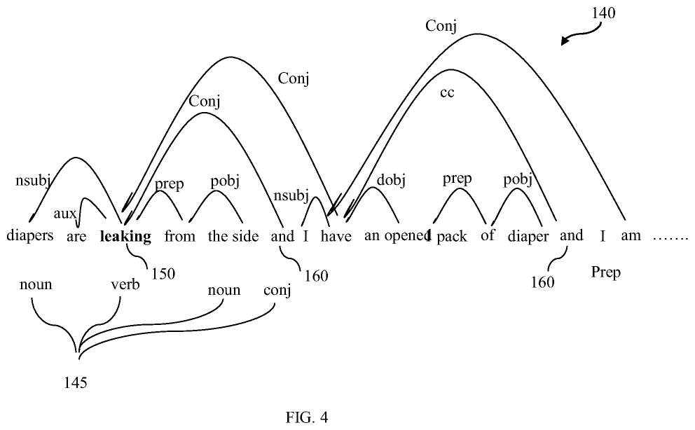

Furthermore, the issue prediction module 100 computes an issue prediction probability for each token based on the machine-readable issue profile 90 obtained by the attention module 70. As used herein, “issue prediction probability” is a probability of a word being used to predict the correct issue. In one embodiment, the issue prediction probability may be computed in percentage, where the percentage represents the weightage given to a input token while classifying a sentence to an issue type. Further, the system 10 includes a phrase extractor subsystem 110 operatively coupled to the customer interaction subsystem 20. The phrase extractor subsystem 110 extracts one or more phrases from the input corpus 30 based on a set of predefined sentencing rules. In one embodiment, the phrase extractor subsystem 110 may create a context graph (later shown in FIG. 4) using each token 80 of the input corpus 30. In such an embodiment, the phrase extractor subsystem 110 may apply the set of predefined sentencing rules on the context graph. In a specific embodiment, the set of predefined sentencing rules may include at least one of a rule for parts of speech, a rule for punctuations, a rule for conjunctions or the like or a combination thereof.

In detail, the phrase extractor subsystem 110 creates nodes which represents the tokens. The phrase extractor subsystem 110 then assigns the set of sentencing rules to each of the token 80 which means each token 80 is tagged with parts of speech such as pronouns, prepositions, verbs, punctuations, conjunctions or the like. The phrase extractor subsystem 110 identifies one or more root verbs in the tokens and creates a context graph based on the tags of the parts of speech. Upon identification of the root verb, the context graph identifies the relation between each token. Then, based on the set of sentencing rules such as conjunctions or punctuations, the phrase extractor subsystem 110 extracts the one or more phrases 115 from the input corpus 30.

Subsequently, the system 10 includes a phrase selector subsystem 120 operatively coupled to the token scorer subsystem 60 and the phrase extractor subsystem 110. The phrase selector subsystem 120 maps each of the one or more phrases 115 extracted by the phrase extractor subsystem 110 with the corresponding issue prediction probability computed by the issue prediction module 100. Further, the phrase selector subsystem 120 determines one or more tokens having the issue prediction probability above a predefined threshold probability. Precisely, the phrase selector subsystem 120 determines the one or more tokens whose percentile of the issue prediction probability is higher than the predefined threshold probability percentile. As a result, the phrase selector subsystem 120 selects at least one phrase 125 from the one or more phrases 115 based on the one or more tokens having higher issue prediction probability than the predefined threshold probability. In another embodiment, the phrase selector subsystem 120 do not select any phrase from the one or more phrases when attention-based token does not comply with the predefined set of sentencing rules. Moreover, the at least one phrase 115 selected by the phrase selector subsystem 120 is used for summarization of the customer interaction.

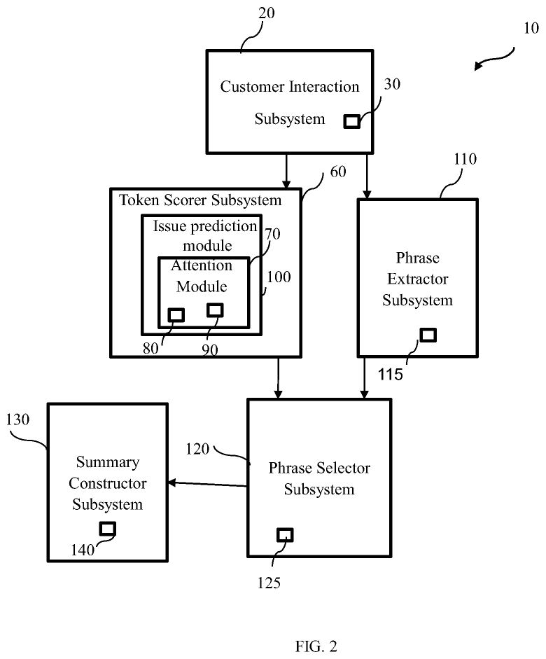

FIG. 2 is a block diagram representation of one embodiment of the system 10 for summarization of customer interaction of FIG. 1 in accordance with an embodiment of the present disclosure. As described in aforementioned FIG. 1, the system 10 includes a customer interaction subsystem 20, a token scorer subsystem 60, a phrase extractor subsystem 110 and a phrase selector subsystem 120. In one embodiment of FIG. 1, the system 10 further includes a summary constructor subsystem 130 operatively coupled to the phrase selector subsystem 120. The summary constructor subsystem 130 creates a summary paragraph 140 corresponding to the customer interaction based on the at least one phrase 125 selected by the phrase selector subsystem 120. In case where phrase selector subsystem 120 selects more than one phrases, the summary constructor subsystem 130 creates the summary by combining the all the phrases selected by the phrase selector subsystem 120.

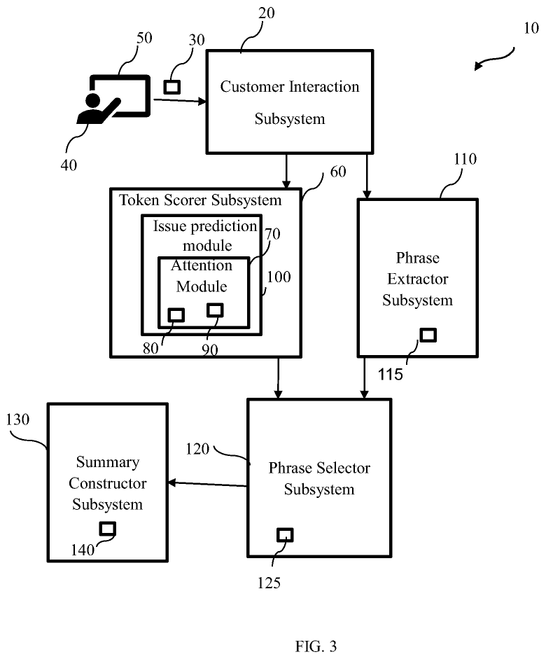

FIG. 3 is a schematic representation of an exemplary system 10 for summarization of customer interaction of FIG. 1 in accordance with an embodiment of the present disclosure. Considering an example where a customer 40 is interacting with a customer interaction subsystem 20 of the system 10 via a customer interface 50. The mode of interaction in such example is a phone call. The customer 40 on the phone call mentioned that “Diapers are leaking from the side and I have an opened pack of diaper and I am not able to return these at store”. The customer interaction subsystem 20 converts message in the phone call into text which may be called as ‘input corpus’ 30. The customer interaction subsystem 20 converts the message of the phone call into text using various natural language speech to text conversion techniques.

Furthermore, the token scorer subsystem 60 of the system 10 includes an issue prediction module 100 which receives the input corpus 30 and identifies boundaries of each word in the input corpus 30 by determining beginning and end points of the words. Upon identification of the boundaries, the issue prediction module 100 splits the input corpus 30 into multiple tokens 80 where each token 80 represent a word such as “Diapers”, “are”, “leaking”, “from”, “the side”, “and”, “I”, “have”, “an opened pack”, “of”, “diaper”, “and”, “I”, “am”, “not”, “able”, “to”, “return”, “these”, “at” and “store”. The attention module 70 assigns machine-readable codes to corresponding tokens 80 and applies various attention models on each token 80 to obtain representation of the sentences such that the representation carries information of context. Upon identification of the context using various attention models, the attention module 70 may identify several details in the input corpus 30 such as a product detail, an issue detail and a customer detail or the like. Once the product, the issue, the customer details are identified in the customer query, the attention module 70 determines a product profile, an issue profile and a customer profile. Each profile attains machine-readable code from the previous profile in the hierarchy and applies the corresponding attention model to generate machine-readable codes for the next profile in the hierarchy.

Based on the application of the various attention models, the attention module 70 obtains the machine-readable issue profile 90. As a result, the issue prediction module 100 of the token scorer subsystem 60 computes an issue prediction probability for each token 80 based on the machine-readable issue profile 90 such as “Diapers with 0.0448 issue prediction probability”, “are with 0.0037 issue prediction probability”, “leaking with 0.5738 issue prediction probability”, “from with 0.0026 issue prediction probability”, “the with 0.0172 issue prediction probability”, “side with 0.3068 issue prediction probability”, “and with 0.0003 issue prediction probability”, “I with 0.0000 issue prediction probability”, “have with 0.0001 issue prediction probability”, “an with 0.0011 issue prediction probability” “opened with 0.0141 issue prediction probability” “pack with 0.0016 issue prediction probability”, “of with 0.0004 issue prediction probability”, “diaper with 0.0116 issue prediction probability”, “and with 0.0002 issue prediction probability”, “I with 0.0001 issue prediction probability”, “am with 0.0001 issue prediction probability”, “not with 0.0002 issue prediction probability”, “able with 0.0015 issue prediction probability”, “to with 0.0001 issue prediction probability”, “return with 0.0056 issue prediction probability”, “these with 0.0007 issue prediction probability”, “at with 0.0000 issue prediction probability” and “store with 0.0122 issue prediction probability”. As a result, the token “leaking” has the highest probability percentage among other tokens.

Simultaneously, the phrase extractor subsystem 110 of the system 10 creates a context graph 140 based on the tokens 80 of the input corpus 30, where tokens 80 are considered as nodes in the context graph 140. Each node in the context graph 140 is tagged with parts of speech 145 such as verbs, conjunctions, prepositions or the like as shown in FIG. 4. The phrase extractor subsystem 110 identifies one or more root verbs such as “leaking” 150 in the input corpus 30 and the relation between each token 80. Further, the phrase extractor subsystem 110 applies a set of predefined sentencing rules on each token 80 such as separate the phrases by eliminating the conjunctions (“and” 160 from the entire input corpus 30 in the aforementioned example). Based on the set of predefined sentencing rules, the phrase extractor subsystem 110 extracts the one or more phrases 115 such as “diapers are leaking from the side”, “I have an opened pack of diaper” and “I am not able to return these at store”.

In addition, the phrase selector subsystem 120 of the system 10 maps each token 80 of the one or more phrase 115 extracted by the phrase extractor subsystem 110 with the corresponding issue prediction probability computed by the issue prediction module 100. The phrase selector subsystem 120 further determines the token 80 which has issue prediction probability greater than a predefined threshold probability. For example, the predefined threshold probability is “95 percentiles” then, the phrase selector subsystem 120 determines that the token “issue” has percentile above “95 percentiles” as compared to other tokens. Hence, the phrase selector subsystem 120 selects the phrase 125 “Diapers are leaking from the side” based on the highest issue probability percentile.

Consequently, the summary constructor subsystem 130 of the system 10 creates a summary paragraph 140 based on the phrase selected by the phrase selector subsystem. Therefore, the phrase 125 “diapers are leaking from the side” may be considered as the summary paragraph 140 created based on the phone call of the customer 40 in the abovementioned example.

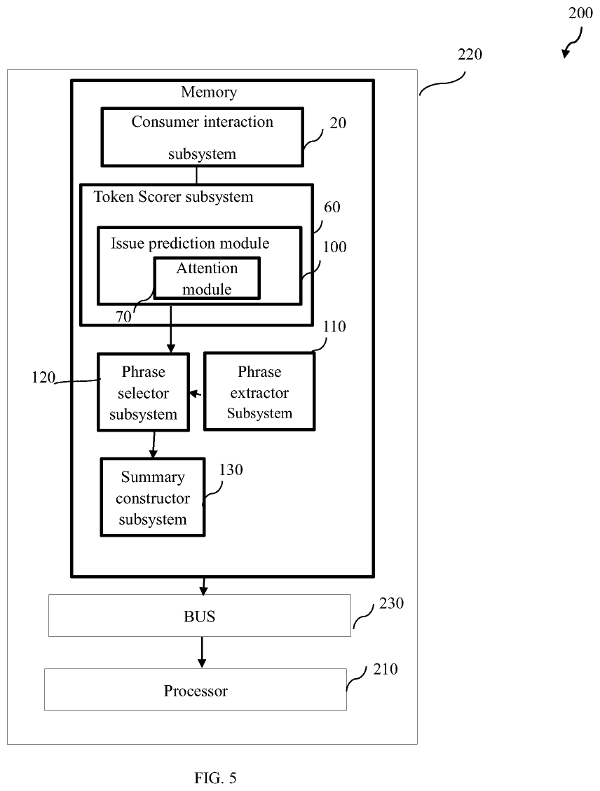

FIG. 5 is a computer or a server 200 for the system for classification of the customer query in accordance with an embodiment of the present disclosure. The server includes processor(s) 210, and memory 220 operatively coupled to the bus 230. The processor(s) 210, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 220 includes a plurality of subsystems stored in the form of executable program which instructs the processor 210 to perform the method steps illustrated in FIG. 1. The memory 220 has following subsystems: a customer interaction subsystem 20, a token scorer subsystem 60 including an issue prediction module 100 having an attention module 70, a phrase extractor subsystem 110, a phrase selector subsystem 120 and a summary constructor 130.

The memory 220 includes a customer interaction subsystem 20 to receive an input corpus from customers. The memory 220 also includes a token scorer subsystem 60 operatively coupled to the customer interaction subsystem 20. The token scorer subsystem 60 includes an issue prediction module 100 to receive multiple tokens 80 by splitting the input corpus 30. The attention module 70 applies attention models hierarchically on the multiple tokens 80 to obtain a machine-readable issue profile 90. The issue prediction module 100 computes an issue prediction probability for each token 80 based on the machine-readable issue profile 90 obtained by the attention module 70.

The memory 220 further includes a phrase extractor subsystem 110 operatively coupled to the customer interaction subsystem 20. The phrase extractor subsystem 110 extracts one or more phrases 115 from the input corpus 30 based on a set of predefined sentencing rules. The memory 220 further includes a phrase selector subsystem 120 operatively coupled to the token scorer subsystem 60 and the phrase extractor subsystem 110. The phrase selector subsystem 120 maps each phrase extracted by the phrase extractor subsystem 110 with the corresponding issue prediction probability computed by the issue prediction module 100. The phrase selector subsystem 120 selects at least one phrase 125 including a token having the issue prediction probability above a predefined threshold probability from the one or more phrases 115 for summarization of customer interaction.

Computer memory 220 elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable programs stored on any of the above-mentioned storage media may be executable by the processor(s) 210.

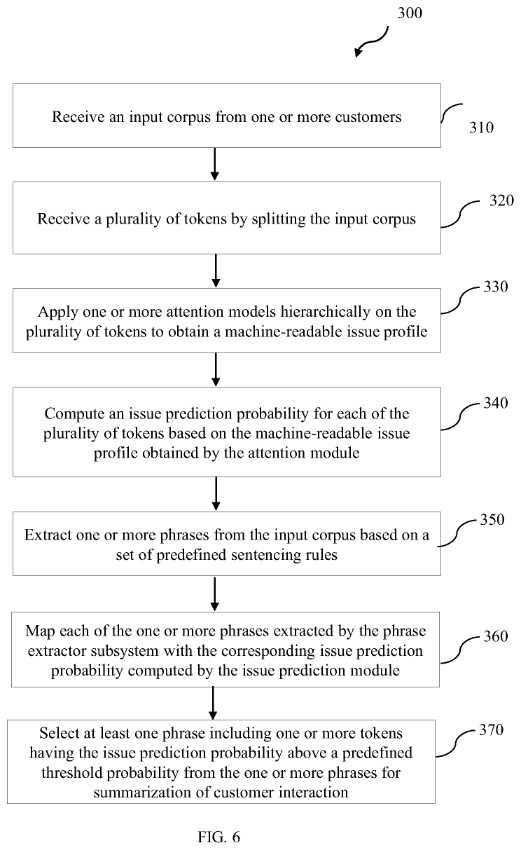

FIG. 6 is a flow chart representing the steps involved in a method 300 for summarization of customer interaction in accordance with an embodiment of the present disclosure. The method 300 includes receiving an input corpus from customers in step 310. In one embodiment, receiving the input corpus from the customers may include receiving the input corpus from the customers by a customer interaction subsystem. In some embodiments, receiving the input corpus from the customers may include receiving text or voice of the customer interaction. In such an embodiment, receiving the text or the voice of the customer interaction may include receiving at least one of web content, text of a chat session, an email, a short messaging service, a voice call or a voice message. In one embodiment, receiving the voice of the customer interaction may include converting the voice of the customer interaction into text using one or more natural language processing models.

Furthermore, the method 300 includes receiving multiple tokens by splitting the input corpus in step 320. In one embodiment, receiving the multiple tokens by splitting the input corpus may include receiving the multiple tokens by splitting the input corpus via an issue prediction module of a token scorer subsystem. In such an embodiment, receiving the multiple tokens may include receiving words, numbers, punctuation marks, date, email address, universal resource locator (URL) or the like. The method 300 further includes applying various attention models hierarchically on the multiple tokens to obtain a machine-readable issue profile in step 330. In one embodiment, applying various attention models hierarchically on the multiple tokens to obtain the machine-readable issue profile may include applying various attention models hierarchically on the multiple tokens to obtain the machine-readable issue profile by the attention module of the token scorer subsystem. In such an embodiment, obtaining the machine-readable issue profile corresponding to the customer interaction may include classifying the plurality of tokens into several profiles using an application of the various attention models.

The method 300 further includes computing an issue prediction probability for each token based on the machine-readable issue profile obtained by the attention module in step 340. In one embodiment, computing the issue prediction probability for each token may include computing an issue prediction probability for each token by the issue prediction module of the token scorer subsystem. As used herein, “issue prediction probability” is a probability of a word being used to predict the correct issue. In one embodiment, the issue prediction probability may be computed in percentage, where the percentage represents the percentage of time require by the attention models to search for a token.

Moreover, the method 300 further includes extracting one or more phrases from the input corpus based on a set of predefined sentencing rules in step 350. In one embodiment, extracting the one or more phrases from the input corpus based on the set of predefined sentencing rules may include extracting the one or more phrases from the input corpus by a phrase extractor subsystem. In a specific embodiment, extracting the one or more phrases from the input corpus may include creating a context graph using the plurality of tokens. In such an embodiment, creating the context graph using the plurality of tokens may include applying the set of predefined sentencing rules on the context graph. In an exemplary embodiment, applying the set of predefined sentencing rules on the context graph may include applying at least one of a rule for parts of speech, a rule for punctuations, a rule for conjunctions or the like or a combination thereof.

Additionally, the method 300 includes mapping each of the one or more phrases extracted by the phrase extractor subsystem with the corresponding issue prediction probability computed by the issue prediction module in step 360. In one embodiment, mapping the one or more phrases with the corresponding issue prediction probability may include mapping the one or more phrases with the corresponding issue prediction probability by a phrase selector subsystem. In a specific embodiment, the method may include determining one or more token having the issue prediction probability above a predefined threshold probability. In such an embodiment, determining the one or more token having the issue prediction probability above the predefined threshold probability may include determining the one or more token whose percentile of the issue prediction probability is higher than the predefined threshold probability percentile. Further, the method 300 includes selecting at least one phrase from the one or more phrases based on the one or more tokens having higher issue prediction probability than the predefined threshold probability for summarization of the customer interaction in step 370. In some embodiments, selecting the at least one phrase from the one or more phrases may include selecting the at least one phrase from the one or more phrases by a phrase selector subsystem.

In one embodiment, the method 300 may include creating a summary paragraph corresponding to the customer interaction based on the at least one phrase selected by the phrase selector subsystem. In such an embodiment, creating the summary paragraph corresponding to the customer interaction based on the at least one phrase selected by the phrase selector subsystem may include creating the summary paragraph corresponding to the customer interaction based on the at least one phrase by a summary constructor subsystem. In case where phrase selector subsystem selects more than one phrases, the summary constructor subsystem creates the summary by combining the all the phrases selected by the phrase selector subsystem.

Various embodiments of the system and method for summarization of the customer interaction described above enables contextually relevant summarization of an input corpus in a simple and quick manner. Furthermore, aforementioned embodiments advantageously provide an automated summarization which is portable across domains. The system overcomes the issues of synonymy and polysemy typically associated with large volume of data as the phrase extractor subsystem extracts meaningful phrases from the input corpus.

The system reduces the user's effort to minutes of the meeting. The system captures verbatim and no additional information is added. The system does not miss details of the conversations as the system captures automated summary from the conversations. The system may exist as part of the telephony system in customer care call-centres, sales calls, business meetings, conferences calls (any multi-user conversation scenario) to capture details from one or more speakers.

It will be understood by those skilled in the art that the foregoing general description and the following detailed description are exemplary and explanatory of the disclosure and are not intended to be restrictive thereof.

While specific language has been used to describe the disclosure, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for summarization of customer interaction comprising:
a customer interaction subsystem configured to receive an input corpus from one or more customers;
a token scorer subsystem operatively coupled to the customer interaction subsystem, wherein the token scorer subsystem comprises:
an issue prediction module configured to receive a plurality of tokens by splitting the input corpus, wherein the issue prediction module comprises:
an attention module configured to apply one or more attention models hierarchically on the plurality of tokens to obtain a machine-readable issue profile,
wherein the issue prediction module is configured to compute an issue prediction probability for each of the plurality of tokens based on the machine-readable issue profile obtained by the attention module;
a phrase extractor subsystem operatively coupled to the customer interaction subsystem, wherein the phrase extractor subsystem is configured to extract one or more phrases from the input corpus based on a set of predefined sentencing rules; and
a phrase selector subsystem operatively coupled to the token scorer subsystem and the phrase extractor subsystem, wherein the phrase selector subsystem is configured to:
map each of the one or more phrases extracted by the phrase extractor subsystem with the corresponding issue prediction probability computed by the issue prediction module; and
select at least one phrase comprising one or more tokens having the issue prediction probability above a predefined threshold probability from the one or more phrases for summarization of customer interaction.

2. The system as claimed in claim 1, wherein the customer interaction subsystem is configured to receive text or voice of the customer interaction.

3. The system as claimed in claim 2, wherein the customer interaction subsystem is configured to convert the voice of the customer interaction into text using one or more natural language processing models.

4. The system as claimed in claim 2, wherein the text or voice of the customer interaction comprises at least one of web content, text of a chat session, an email, a short messaging service, a voice call or a voice message.

5. The system as claimed in claim 1, wherein the plurality of tokens comprises words, numbers, punctuation marks, date, email address or universal resource locator (URL).

6. The system as claimed in claim 1, wherein the attention module is configured to obtain the machine-readable issue profile corresponding to the customer interaction by classifying the plurality of tokens into a plurality of profiles using an application of the one or more attention models.

7. The system as claimed in claim 1, wherein the phrase extractor subsystem is configured to extract the one or more phrases from the input corpus by creating a context graph using the plurality of tokens and applying the set of predefined sentencing rules on the context graph.

8. The system as claimed in claim 1, wherein the set of predefined sentencing rules comprises at least one of a rule for parts of speech, a rule for punctuations, a rule for conjunctions or a combination thereof.

9. The system as claimed in claim 1, further comprising a summary constructor subsystem operatively coupled to the phrase selector subsystem, wherein the summary constructor subsystem is configured to create a summary paragraph corresponding to the customer interaction based on the at least one phrase selected by the phrase selector subsystem.

10. A method for summarization of customer interaction comprising:
receiving, by a customer interaction subsystem, an input corpus from one or more customers;
receiving, by an issue prediction module, a plurality of tokens by splitting the input corpus;
applying, by an attention module, one or more attention models hierarchically on the plurality of tokens to obtain a machine-readable issue profile;
computing, by the issue prediction module, an issue prediction probability for each of the plurality of tokens based on the machine-readable issue profile obtained by the attention module;
extracting, by a phrase extractor subsystem, one or more phrases from the input corpus based on a set of predefined sentencing rules;
mapping, by a phrase selector subsystem, each of the one or more phrases extracted by the phrase extractor subsystem with the corresponding issue prediction probability computed by the issue prediction module; and
selecting, by the phrase selector subsystem, at least one phrase comprising one or more tokens having the issue prediction probability above a predefined threshold probability from the one or more phrases for summarization of customer interaction.

11. The method as claimed in claim 10, wherein obtaining the machine-readable issue profile corresponding to the customer interaction comprises classifying the plurality of tokens into a plurality of profiles using an application of the one or more attention models.

12. The method as claimed in claim 10, wherein extracting the one or more phrases from the input corpus comprises creating a context graph using the plurality of tokens.

13. The method as claimed in claim 12, wherein creating the context graph using the plurality of tokens comprises applying the set of predefined sentencing rules on the context graph.

14. The method as claimed in claim 10, further comprising creating, by a summary constructor subsystem, a summary paragraph corresponding to the customer interaction based on the at least one phrase selected by the phrase selector subsystem.
